(19) United States
(12) Patent Application Publication
(10) Pub. No.: US 2016/0362276 A1
(43) Pub. Date: Dec. 15, 2016

(54) DRIVE ASSISTED EMERGENCY STOP

(71) Applicant: OTIS ELEVATOR COMPANY, Farmington, CT (US)

(72) Inventors: Yang Wang, Shenzhen (CN); Shashank Krishnamurthy, Glastonbury, CT (US); HanJong Kim, Avon, CT (US); Ismail Agirman, Southington, CT (US)

(21) Appl. No.: 15/178,608

(22) Filed: Jun. 10, 2016

Related U.S. Application Data
(60) Provisional application No. 62/173,429, filed on Jun. 10, 2015.

(51) Int. Cl. B66B 5/02; B66B 5/16

(52) U.S. Cl. CPC B66B 5/027; B66B 5/16

(57) ABSTRACT

A method of stopping an elevator in the event of a power failure is provided. The method includes determining that a power source for a drive system of an elevator has failed, retaining energy electrically separate from the power source, managing the retained energy to enable drive-assisted emergency stopping of an elevator, and stopping an elevator using the managed, retained energy.

### CROSS-REFERENCE TO RELATED APPLICATIONS

This application claims the benefit of U.S. Provisional Application Ser. No. 62/173,429 entitled “Drive Assisted Emergency Stop,” filed Jun. 10, 2015, under 35 U.S.C. §119(e), and which is incorporated herein by reference in its entirety.

### BACKGROUND

The subject matter disclosed herein generally relates to emergency stopping of elevators and, more particularly, to drive assisted emergency stopping of elevators.

Elevators use a motor to both decelerate the elevator car and hold the elevator car in position (e.g., at a landing). In elevators, normal deceleration and leveling of the elevator car may be performed by varying drive signals applied to the motor. A brake is typically engaged only in certain situations to hold or secure the elevator car in a stopped position.

For example, in existing elevator systems, when a power outage occurs, or there is a power failure with respect to the power supplied to an elevator system, a failsafe mechanical emergency brake may be configured to automatically close or engage, thus stopping an elevator car and holding the elevator car in a stopped position. The closing of the emergency brake is triggered by the loss of power, and is configured to stop an elevator car from falling in an elevator shaft. The emergency brake may be closed by a spring force, or similar mechanism, to rapidly, instantly, or nearly instantly stop the elevator car within the elevator shaft.

### BRIEF DESCRIPTION

According to one embodiment a method of stopping an elevator in the event of a power failure is provided. The method includes determining that a power source for a drive system of an elevator has failed, retaining energy electrically separate from the power source, managing the retained energy to enable drive-assisted emergency stopping of an elevator, and stopping an elevator using the managed, retained energy.

In addition to one or more of the features described above, or as an alternative, further embodiments may include that the retention of energy is stored within at least one component of the drive system.

In addition to one or more of the features described above, or as an alternative, further embodiments may include that the component is at least one of a motor, an inverter, a dynamic brake resistor, a converter, an inductor, and an EMI filter.

In addition to one or more of the features described above, or as an alternative, further embodiments may include controlling at least one of a DC bus voltage and a velocity of an elevator car to control an emergency stop of the elevator car.

In addition to one or more of the features described above, or as an alternative, further embodiments may include determining and activating an emergency stop mode of the drive system when it is determined the power has failed.

In addition to one or more of the features described above, or as an alternative, further embodiments may include that the emergency stop mode is determined based on a state of the elevator car at the time it is determined the power has failed.

In addition to one or more of the features described above, or as an alternative, further embodiments may include that the state of the elevator car is at least one of (i) a direction of movement of the elevator car and (ii) a load in the elevator car.

In addition to one or more of the features described above, or as an alternative, further embodiments may include controlling the position of an elevator car to position the elevator at a target position.

In addition to one or more of the features described above, or as an alternative, further embodiments may include that the target position is proximate to at least one of a landing door and an exit from an elevator shaft.

In addition to one or more of the features described above, or as an alternative, further embodiments may include engaging a mechanical emergency brake when the elevator car is in the target position.

In addition to one or more of the features described above, or as an alternative, further embodiments may include engaging a mechanical emergency brake if the retained energy is depleted.

In addition to one or more of the features described above, or as an alternative, further embodiments may include electrically separating the drive system from the power source when the power fails.

In addition to one or more of the features described above, or as an alternative, further embodiments may include that the power source is a power grid.

According to another embodiment, a system for stopping an elevator car during a power failure of a power source is provided. The system includes a drive system configured to drive an elevator within an elevator shaft, the drive system having an electrical system and a motor and a controller configured to (i) manage retained energy, (ii) determine if a power source has failed, and (iii) control the drive system to assist an emergency stop of an elevator car.

In addition to one or more of the features described above, or as an alternative, further embodiments may include that at least one of the electrical system and the motor are configured to retain energy, wherein the retained energy is the energy managed by the controller.

In addition to one or more of the features described above, or as an alternative, further embodiments may include that the electrical system includes at least one of an inverter, a dynamic brake resistor, a converter, an inductor, and an EMI filter.

In addition to one or more of the features described above, or as an alternative, further embodiments may include that the controller is configured to control at least one of a DC bus voltage and a velocity of an elevator car to control an emergency stop of the elevator car.

In addition to one or more of the features described above, or as an alternative, further embodiments may include that the controller is configured to determine and activate an emergency stop mode of the drive system when it is determined the power has failed.

In addition to one or more of the features described above, or as an alternative, further embodiments may include that the emergency stop mode is determined based on a state of the elevator car at the time it is determined the power has failed.

In addition to one or more of the features described above, or as an alternative, further embodiments may include that the state of the elevator car is at least one of (i) a direction of movement of the elevator car and (ii) a load in the elevator car.

In addition to one or more of the features described above, or as an alternative, further embodiments may include that wherein at least one of the controller and the drive system are configured to control the position of an elevator car to position the elevator at a target position.

In addition to one or more of the features described above, or as an alternative, further embodiments may include that the target position is proximate to at least one of a landing door and an exit from an elevator shaft.

In addition to one or more of the features described above, or as an alternative, further embodiments may include a mechanical emergency brake configured to engage when the elevator car is in the target position.

In addition to one or more of the features described above, or as an alternative, further embodiments may include a mechanical emergency brake configured to engage when the retained energy is depleted.

In addition to one or more of the features described above, or as an alternative, further embodiments may include a means for electrically separating the drive system from the power source when the power fails.

In addition to one or more of the features described above, or as an alternative, further embodiments may include that the power source is a power grid.

Technical effects of embodiments of the disclosure include methods and systems for providing emergency stopping of an elevator car through continued operation of a motor and/or drive system after power fails. Further technical effects include stopping an elevator car smoothly and/or at a target location when power fails.

### BRIEF DESCRIPTION OF THE DRAWINGS

The subject matter which is particularly pointed out and distinctly claimed in the claims at the conclusion of the specification. The foregoing and other features and advantages of the disclosure are apparent from the following detailed description taken in conjunction with the accompanying drawings in which:

FIG. 1 is a schematic illustration of an elevator system that may employ various embodiments of the disclosure;

FIG. 2 is a schematic illustration of a drive system in accordance with an exemplary embodiment of the disclosure;

FIG. 3 is a process in accordance with an exemplary embodiment of the disclosure;

FIG. 4 is a mode of operation in accordance with an exemplary embodiment of the disclosure; and

FIG. 5 is an alternative mode of operation in accordance with an exemplary embodiment of the disclosure.

### DETAILED DESCRIPTION

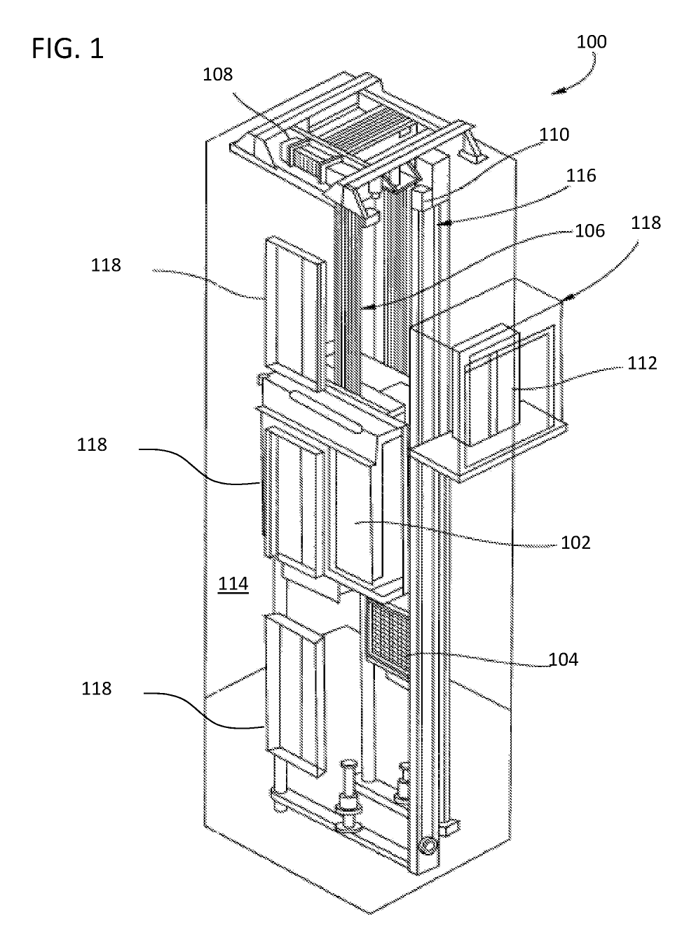

FIG. 1 is a perspective view of an elevator system 100 including an elevator car 102, a counterweight 104, roping 106, a machine 108, a position encoder 110, and a controller 112. The elevator car 102 and counterweight 104 are connected to each other by the roping 106. The roping 106 may include or be configured as, for example, ropes, steel cables, and/or coated-steel belts. The counterweight 104 is configured to balance a load of the elevator car 102 and is configured to facilitate movement of the elevator car 102 concurrently and in an opposite direction with respect to the counterweight 104 within an elevator shaft 114.

The roping 106 engages the machine 108, which is part of an overhead structure of the elevator system 100. The machine 108 is configured to control movement between the elevator car 102 and the counterweight 104. The position encoder 110 may be mounted on an upper sheave of a speed-governor system 116 and may be configured to provide position signals related to a position of the elevator car 102 within the elevator shaft 114. In other embodiments, the position encoder 110 may be directly mounted to a moving component of the machine 108, or may be located in other positions and/or configurations as known in the art.

The controller 112 is located, as shown, in a controller room 118 of the elevator shaft 114 and is configured to control the operation of the elevator system 100, and particularly the elevator car 102. For example, the controller 112 may provide drive signals to the machine 108 to control the acceleration, deceleration, leveling, stopping, etc. of the elevator car 102. The controller 112 may also be configured to receive position signals from the position encoder 110. When moving up or down within the elevator shaft 114, the elevator car 102 may stop at one or more landings 118 as controlled by the controller 112. Although shown in a controller room 118, those of skill in the art will appreciate that the controller 112 can be located and/or configured in other locations or positions within the elevator system 100.

The machine 108 may include a motor or similar driving mechanism. In accordance with embodiments of the disclosure, the machine 108 is configured to include an electrically driven motor. The power supply for the motor may be nay power source, including a power grid, which, in combination with other components, is supplied to the motor. The motor may be configured as a regenerative motor, as known in the art, and thus include associated components and features.

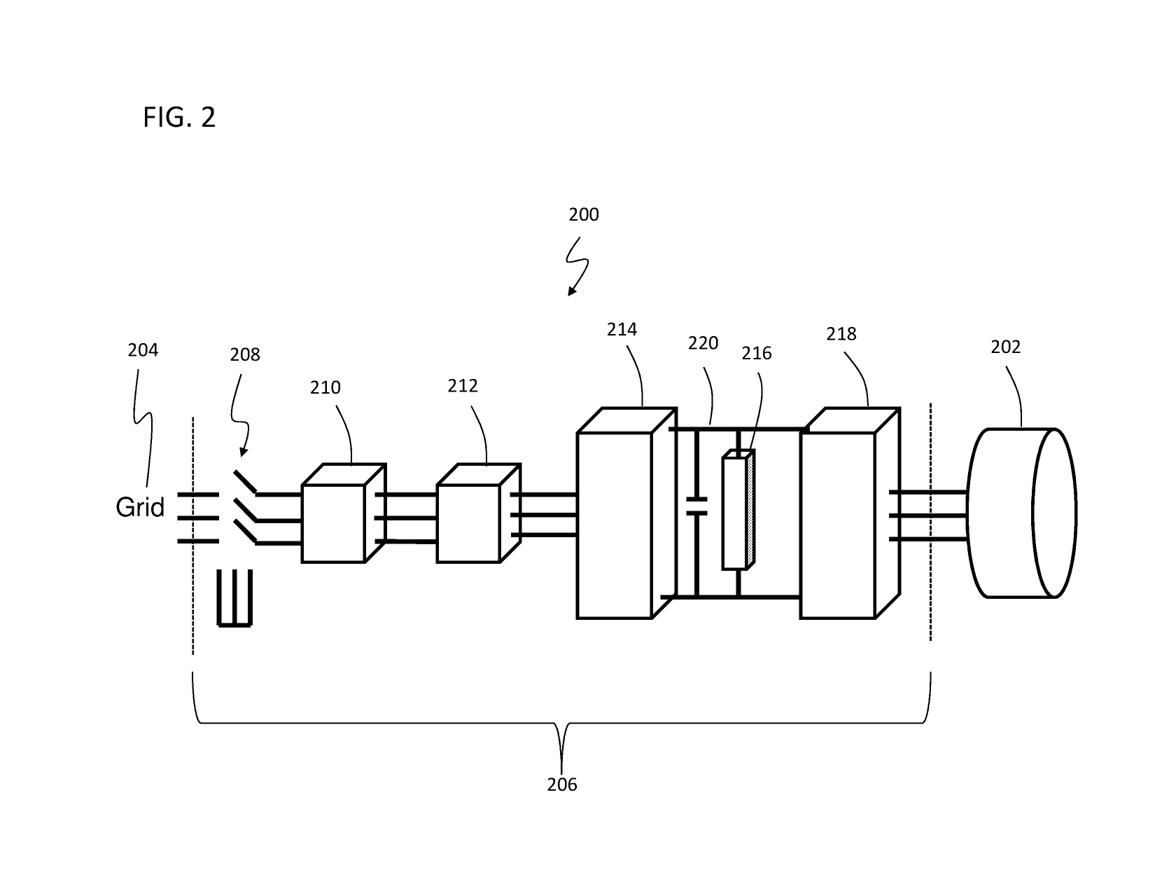

Turning to FIG. 2, a schematic illustration of a drive system 200, including a motor 202 and electrical power configuration 206, in accordance with an exemplary embodiment of the disclosure is shown. The motor 202 is driven by power supplied from the power source 204. The electrical system 206 is configured to provide energy conversion, storage, etc. to the drive system 200, and particularly to supply power from the power source 204 to the motor 202.

The electrical system 206 includes, for example, a single-pole-double-throw (SPDT) contactor 208, an electromagnetic interference (“EMI”) filter 210, one or more boost inductors 212, a convertor 214, a dynamic brake 216, and an inverter 218. Components of the drive system 200 are connected by an electrical bus 220, such as a DC bus. Although only certain components are shown and described as part of the electrical system 206, those of skill in the art will appreciate that other components may be used in addition to or instead of the components described herein. Further, although shown in a particular order and configuration in FIG. 2, those of skill in the art will appreciate that alternative configurations may be employed without departing from the scope of the disclosure.

The electrical system 206 may be configured to store, sink, retain, etc. energy. The energy stored or retained within the electrical system 206 may be used during a power failure to enable the motor 202 to operate and enable control of an elevator car after a power failure. That is, during a power failure, such as when power is no longer available from the power source 204, a traditional system may not permit the motor to operate, and the emergency brakes of the system would engage, rapidly stopping an elevator wherever it may be located at the time of the power failure. Such system may cause a harsh or unpleasant stopping and/or may not stop the elevator at a location that is ideal for exiting the elevator and/or for rescue.

In contrast, embodiments of the disclosure enable energy stored or retained in the electrical system 206 and/or within the motor 202 to provide sufficient electrical power to control or assist in braking of an elevator car during a power failure scenario. For example, embodiments of the disclosure provide for continued operation of the drive system 200, and particularly motor 202, after power from the power source 204 fails. Thus, an elevator car that is driven by drive system 200 may be stopped relatively smoothly and/or stopped at a landing or other door zone that may enable any passengers to be evacuated from the elevator car. That is, in some embodiments of the disclosure, the elevator to not be stopped between landings within an elevator shaft but rather positioned at a preferred or ideal location/position.

The energy of the drive system 200 may be stored or dissipated in one or more components of the drive system 200. For example, the motor 202 may act or operate as an energy-sink due to copper and iron loss in the motor. The inverter 218 may acts as an energy-sink due to the action of switching and conduction loss, as known in the art. The dynamic brake resistor 216 can be dynamically connected to and disconnected from the bus 220. When the dynamic brake resistor 216 is connected to the bus 220, the dynamic brake resistor 216 consumes energy from the bus 220 and when the dynamic brake resistor 216 is disconnected from the bus 220, it does not consume energy.

The converter 214, the boost inductors 212, and the EMI filter 210 are configured to work together with the contactor 208 in order to sink or retain regenerative energy after a failure of power power source 204. For example, the contactor 208 may be configured to connect the drive system 200 to the power power source 204 when the power source 204 is operating normally, that is, continuously supplying power. When the power power source 204 is operating and supplying power, the contactor 208 is in a configuration to provide power to the drive system 200. However, when there is a failure of power from power source 204, i.e., power is no longer available from the power source 204; the contactor 208 is configured to disconnect the drive system 200 at the time of power failure, thus electrically isolating the drive system 200 from the power source 204.

When the connector 208 disconnects the drive system 200 from the power source 204, the connector 208 may automatically short the EMI filter 210. For example, the connector 208 may be configured to short three terminals of the EMI filter 210 in order to allow current flow in the EMI filter 210, the boost inductors 212, and the converter 214. As such, the EMI filter 210, the boost inductors 212, and the converter 214 can be used as energy sinks or configured to retain energy. For example, the converter 214 can sink energy due to switching and conduction loss, the boost inductors 212 can sink energy due to the loss in windings and magnetic core of the inductors, and the EMI filter 210 can sink energy due to conductive loss.

The energy that is retained within the drive system 200, after a power failure of power source 204, may be used to actively control an elevator car to be stopped smoothly and/or at a target position, such as at a proper landing zone for passenger evacuation. Such a system may be controlled by a controller, for example controller 112 shown in FIG. 1, or by another controller or computing system, as known in the art. The controller may be configured to operate and affect an emergency stop during a power failure. When a power failure occurs, a process or logic is performed to operate and control an elevator car to provide a smooth emergency stop and/or to position the elevator car at a desired position, such as proximal to a landing door which may allow for easy and safe evacuation from the elevator car.

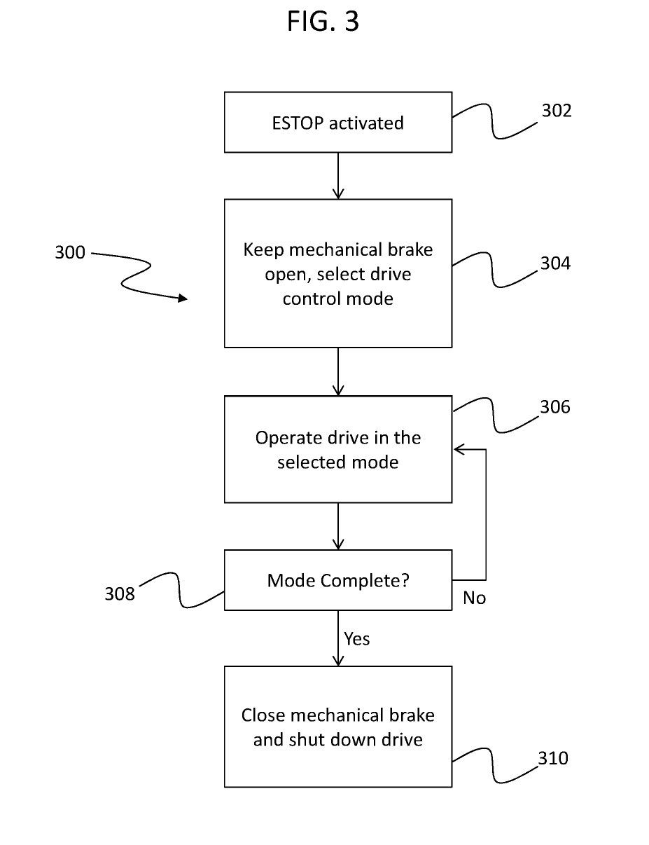

Referring now to FIG. 3, an exemplary process in accordance with the disclosure is shown. Process 300 is initiated during a power failure of a power source, such as grid failure, or other power failure that prevents an elevator drive system from being supplied with power. At step 302 an emergency stop (“ESTOP”) process is activated. The ESTOP process is triggered by a power failure. During step 302, the drive system of the elevator is electrically isolated from the power source, such as described above, and the retained or stored energy within the system may be used for the process 300.

Once the ESTOP process is activated at step 302, the controller of the system keeps the mechanical emergency brake open and selects a drive control mode at step 304. The mechanical emergency brake is held open so that a sudden stop does not immediately occur. That is, even though there has been a power failure, because there is retained or stored energy in the drive system of the elevator, the mechanical emergency brake is not immediately required, and a controlled or drive assisted emergency stop may be performed.

Also during step 304 a control mode of the drive system is selected by the controller. The control mode may be selected based on a number of factors that are present at the time the ESTOP process is activated at step 302. The selection of a control mode may be based on factors including, but not limited to, the direction the car is moving (e.g., upward, downward, stationary) and the load within the car (e.g., are passengers within the car). The load may be determined, for example, by load weighing information and/or by a magnitude and polarity of a motor torque current.

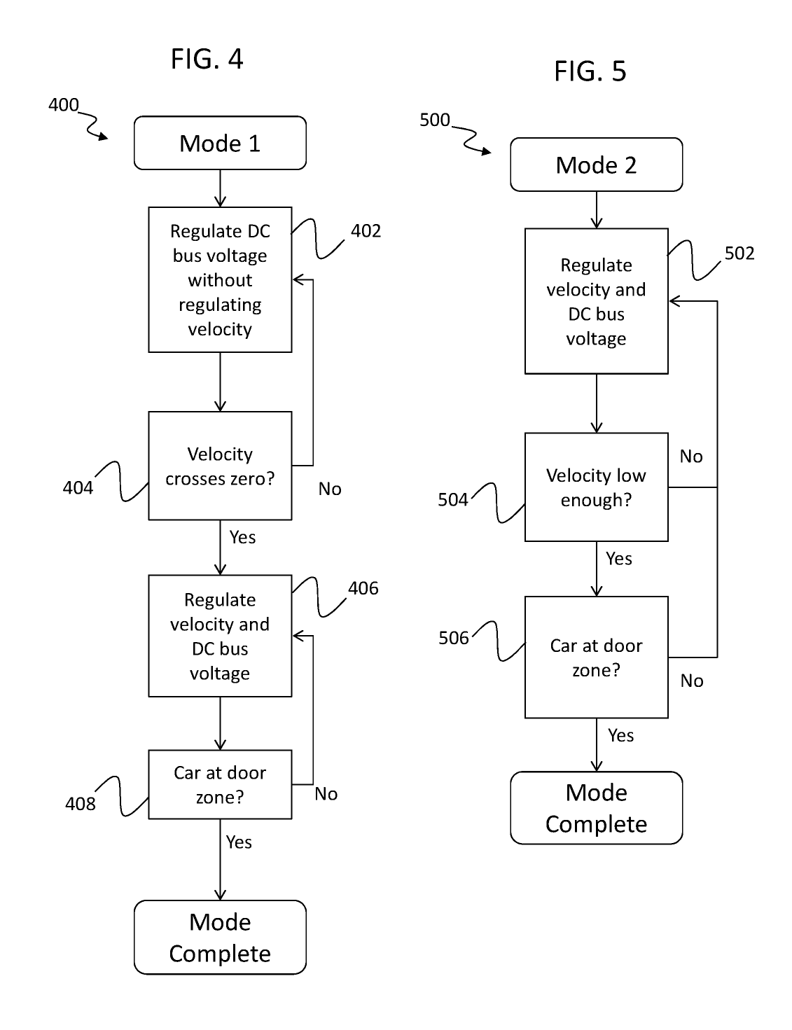

Two exemplary control modes, in accordance with exemplary embodiments of the disclosure, are described below with respect to FIGS. 4 and 5. Once the control mode is selected or determined at step 304, the drive system is operated or controlled to operate in accordance with the selected control mode at step 306.

At step 308 a determination is made whether the selected control mode is complete. If it is determined at step 308 that the control mode is not complete, the process returns to step 306 and continues to operate and control the drive system in accordance with the selected control mode. However, if it is determined that the selected control mode is complete, as determined, for example, in FIGS. 4 and 5, the mechanical brake is closed and the drive system is shut down. The mechanical brake is configured to hold or retain the elevator car in the position that is achieved during the process 300, without the need for external energy applied thereto.

Turning now to FIG. 4, an exemplary drive control mode in accordance with embodiments of the disclosure is shown. Mode or process 400 is indicated as “Mode 1” and may be one of the control modes available for selection by the controller during step 304 of process 300 shown in FIG. 3.

Mode 400 begins at step 402 by regulating the DC bus voltage of the drive system without regulating the velocity of the elevator car within the elevator shaft. The elevator car velocity is monitored, and at step 404 it is determined if the velocity of the elevator car crosses zero. This may occur if the elevator car is moving in an elevator shaft upward with a full load or downward when empty at the time of a power failure. When moving upward, the momentum may continue to carry the elevator car upward, with the elevator car decelerating, and the velocity reducing to zero or close to zero before potentially accelerating downward. Once the elevator crosses the zero velocity range, in this mode, the brake may be engaged in a low energy state allowing for a smooth stop when the power is lost, which may be between floors. Further, in this mode, the elevator car can be speed regulated, during a power failure, to land the elevator car at a landing or door zone.

At step 404, if it is determined that the velocity has not crossed zero, the process returns back to step 402 and continues to regulate the DC bus voltage without regulating the velocity. It is then again determined if the velocity has crossed zero at step 404.

However, if it is determined that the velocity has crossed zero at step 404, step 406 is carried out and the DC bus voltage and the velocity are both regulated. The velocity may be regulated at step 406 to move the elevator car within the elevator shaft using the stored or retained power within the drive system, such as described above. The drive system may be operated to move the car, i.e., regulating the velocity, to position the car at a target position or location, such as a predetermined position, e.g., at a landing or proximal to a landing or exit in the elevator shaft. In some embodiments, the controller may control the velocity at a fixed, low absolute value in order to facilitate moving and parking the elevator car at the target position precisely.

At step 408, it is determined if the elevator car is located at the target position. If, at step 408, it is determined that the elevator car is not located at the target position, step 406 is repeated and the controller regulates the velocity and the DC bus voltage to move the elevator car to the target position. That is, the controller and process are configured to move the car to an appropriate position for evacuation, etc.

If, at step 408, it is determined that the elevator car is located at the target position, the mode is indicated as complete. After this, as indicated in process 300 of FIG. 3, the emergency mechanical brake is engaged, and the elevator car is held or maintained at the target position.

Turning now to FIG. 5, a different or alternative process, referred to as “Mode 2” is shown. Mode 500 may be activated or selected when the elevator car is moving in the elevator shaft downward with a full car load or empty and traveling upward when a power failure occurs. That is, the elevator car will already be moving downward and gravity will not slow the elevator car. Thus the drive system may be employed to slow the elevator car relatively quickly, without initiating a full-stop that is affected by the mechanical emergency brake. Thus at step 502 of Mode 2, the controller immediately regulates both the velocity and the DC bus voltage of the drive system. This operation will consume some of the energy that has been stored or retained in the drive system at the time of the power failure.

Then, at step 504, it is determined if the velocity is low enough, such as approaching zero, to provide additional control. If it is determined that the velocity is too high, step 502 will be repeated and the velocity and DC bus voltage will continue to be regulated. The system will then perform step 504 again, and check if the velocity is low enough for additional control. If it is determined that the velocity is low enough, the process will continue to step 506. At step 506, it is determined whether the elevator car is at a target position, such as at or proximal to a landing door or exit in the elevator shaft. If it is determined that the elevator car is not located or positioned at the target position, the velocity and DC bus voltage will be regulated (step 502) to move the car to the selected location. If it is determined that the elevator car is at the target position, the process completes. Subsequently, as noted in FIG. 3, the mechanical emergency brake is engaged to hold the elevator at the target position.

It will be appreciated by those of skill in the art that the determining of the velocity and position of the elevator car may be determined by the position encoder described above and/or one or more sensors in the elevator shaft and/or connected to the elevator car. Such sensors may be in communication with the controller or other decision making device. Further, the target position may be a position that is relative to any landing within an elevator shaft, and is not limited to a single designated floor. For example, the target position or location may be the closest landing that is below the elevator car when the step of locating the car at the target position is made, e.g., step 408 and step 506. In alternative embodiments, the target position or location may be any position or location in the elevator shaft which may be predetermined.

In accordance with various embodiments of the disclosure, during the stage of regulating velocity and DC bus voltage, such as in the Modes described above, the motor and drive system may be configured and controlled to operate in a regulated regeneration mode. Because the power from the power source is absent at this point, the system actively dissipates the regenerative energy locally within the system so as to control the DC bus voltage.

It will be appreciated by those of skill in the art that the above described system employs the stored or retained power, and thus there may be a limited power supply to perform the above described process(es). In the event the remaining power is insufficient to move the elevator car to a target position, the emergency mechanical brake will engage and secure the elevator car in whatever position the elevator car is when the retained energy is depleted. Thus, even if there is insufficient power to move the elevator car to a target position, embodiments of the disclosure may still provide a drive assisted and controlled stopping of the elevator car during a power failure.

As noted, the decision making and mode selection may be based upon the state of the elevator car at the time of the power failure. The decision process for determining a mode of operation follows. In the below description, the reference directions of the vectors of force downward is positive, deceleration downward is positive, and velocity upward is positive, relative to or within an elevator shaft. The purpose of defining the reference directions is to unify all scenarios regardless of whether the elevator car is traveling up or down within the elevator shaft.

A controller or processor may calculate the natural deceleration vector \vec{D_{NAT}} of the elevator car using the following equation:

$$\vec{{D}_{NAT}} = \frac{( {M}_{load} + {M}_{car} - {M}_{cwt} ) \times ℊ + \vec{{F}_{FR}}}{{M}_{load} + {M}_{car} + {M}_{cwt}} \qquad ( 1 )$$

In equation (1), M_{load} is i the mass of the load in the car, M_{car} is the mass of the car, M_{cwt} is the mass of the counter-weight, g is the gravitation constant (≈9.81 m/s²), and \vec{F_{FR}} is the friction force vector applied to the moving system.

Depending on a velocity vector V of the elevator car and a predefined maximum deceleration rate D_{MAX} an allowed deceleration vector may be determined:

\vec{D_{allow}}=sign(\vec{V})×D_{MAX} (2)

The controller or processor will then compare \vec{D_{NAT}} with \vec{D_{allow}}. In this exemplary embodiment, there are two possible cases that may be considered by the controller or processor. As will be appreciated by those of skill in the art, the sign function where when the argument is negative it returns a “−1,” if positive it returns a “1,” and if zero it returns “0.”

In Case 1, the total gravitational force and friction slow the car down at a deceleration rate higher than D_{MAX}. This is represented mathematically as:

\vec{D_{NAT}}·\vec{D_{allow}}≧|\vec{D_{allow}}|² (3)

In Case 2, the total gravitational force and friction either slow the car down at a deceleration rate lower than D_{MAX} or accelerates the car. This is represented mathematically as:

\vec{D_{NAT}}·\vec{D_{allow}}<|\vec{D_{allow}}|² (4)

Using the above logic, if Case 1 is found or calculated, Mode 1 (FIG. 4) may be activated and if Case 2 is found or calculated, Mode 2 (FIG. 5) may be activated.

The control of the velocity in either of the above Modes, or in other modes of operation in accord with embodiments of the disclosure, may be a time varying velocity command. A time varying velocity command \vec{v_{cmd}}(t) may be generated using the following equation:

$$\{ \begin{matrix}\vec{{v}_{cmd}} ( t ) = \vec{V} - \int \vec{{D}_{allow}} \cdot d t , if \vert \vec{{v}_{cmd}} ( t ) \vert > {V}_{final} \\ \vec{{v}_{cmd}} ( t ) = sign ( \vec{V} ) \cdot {V}_{final} , otherwise\end{matrix} \qquad ( 5 )$$

In accordance with various embodiments of the disclosure, the final velocity V_{final} at which the car approaches the target position may need to be low enough to ensure parking precision at the target position.

In some embodiments, the drive and control system may be configured to respond to power source recovery. That is, although the process(es) described herein may be initiated due to a power failure in a power source, such as a power grid, if the power is restored during one or more of the processes described herein, the system may be configured to safely respond to such resumption of power from the power source, without negatively impacting the elevator system.

Advantageously, embodiments of the disclosure provide an elevator emergency stopping system that may provide a drive assisted stopping that may allow for a smooth stop during a power failure. Further, advantageously, smooth deceleration, as enabled by embodiments of the disclosure, during an emergency stop may improve both the mechanical brake life and passenger experience during an emergency stop. Further, advantageously, although batteries may be employed in various embodiments, implementation of various other embodiments in accordance with the disclosure may not require an additional battery or power source. Furthermore, advantageously, embodiments of the disclosure may enable low-cost configurations due to minimal changes to existing systems and/or the ability to eliminate or not require an additional battery or other power source. Moreover, operation in accordance with various embodiments of the disclosure may not require operation of the emergency mechanical brake until the elevator car is stopped or nearly stopped.

Moreover, advantageously, drive-assisted braking in accordance with embodiments of the disclosure does not require additional device(s) or components in order to regulate the force applied by the mechanical brake. As such, there may be an increase in mechanical brake life.

Furthermore, advantageously, embodiments of the disclosure may enable an elevator car to be stopped during an emergency power failure at a reduced stopping force. For example, forces of 0.4 g or lower may be achieved, rather than 0.7 g during application of a mechanical brake without drive assisted and/or controlled stopping.

While the disclosure has been described in detail in connection with only a limited number of embodiments, it should be readily understood that the disclosure is not limited to such disclosed embodiments. Rather, embodiments of the disclosure can be modified to incorporate any number of variations, alterations, substitutions, combinations, sub-combinations, or equivalent arrangements not heretofore described, but which are commensurate with the spirit and scope of the disclosure. Additionally, while various embodiments of the disclosure have been described, it is to be understood that aspects of the disclosure may include only some of the described embodiments.

For example, although various orders or steps and configurations of components are shown and described herein, those of skill in the art will appreciate that other orders and/or configurations, including additional steps and/or components may be employed without departing from the scope of the disclosure. Furthermore, although described with various components and/or elements of the drive system operating as energy sinks for providing power to the drive system after a power failure, alternative energy sinks may be employed without departing from the scope of the disclosure. For example, building loads may be used as energy sink alternatives to be used separately and/or in combination with the systems described above.

Further, as described herein with respect to a power failure, and specifically to grid-based-failures, those of skill in the art will appreciate that the described disclosure may not be necessary for other types of stopping and/or emergency stopping, and thus embodiments of the disclosure may be employed with and not interfere or affect other types of stopping mechanisms of an elevator car.

Accordingly, the disclosure is not to be seen as limited by the foregoing description, but is only limited by the scope of the appended claims.

What is claimed is:

1. A method of stopping an elevator in the event of a power failure, the method comprising:
determining that a power source for a drive system of an elevator has failed;
retaining energy electrically separate from the power source;
managing the retained energy to enable drive-assisted emergency stopping of an elevator; and
stopping an elevator using the managed, retained energy.

2. The method of claim 1, wherein the retention of energy is stored within at least one component of the drive system.

3. The method of claim 2, wherein the component is at least one of a motor, an inverter, a dynamic brake resistor, a converter, an inductor, and an EMI filter.

4. The method of claim 1, further comprising controlling at least one of a DC bus voltage and a velocity of an elevator car to control an emergency stop of the elevator car.

5. The method of claim 1, further comprising determining and activating an emergency stop mode of the drive system when it is determined the power has failed.

6. The method of claim 5, wherein the emergency stop mode is determined based on a state of the elevator car at the time it is determined the power has failed.

7. The method of claim 6, wherein the state of the elevator car is at least one of (i) a direction of movement of the elevator car and (ii) a load in the elevator car.

8. The method of claim 1, further comprising controlling the position of an elevator car to position the elevator at a target position.

9. The method of claim 8, wherein the target position is proximate to at least one of a landing door and an exit from an elevator shaft.

10. The method of claim 8, further comprising engaging a mechanical emergency brake when the elevator car is in the target position.

11. The method of claim 1, further comprising engaging a mechanical emergency brake if the retained energy is depleted.

12. The method of claim 1, further comprising electrically separating the drive system from the power source when the power fails.

13. A system for stopping an elevator car during a power failure of a power source, the system comprising:
a drive system configured to drive an elevator within an elevator shaft, the drive system having an electrical system and a motor; and
a controller configured to (i) manage retained energy, (ii) determine if a power source has failed, and (iii) control the drive system to assist an emergency stop of an elevator car.

14. The system of claim 13, wherein at least one of the electrical system and the motor are configured to retain energy, wherein the retained energy is the energy managed by the controller.

15. The system claim 13, wherein the electrical system includes at least one of an inverter, a dynamic brake resistor, a converter, an inductor, and an EMI filter.

16. The system of claim 13, wherein the controller is configured to control at least one of a DC bus voltage and a velocity of an elevator car to control an emergency stop of the elevator car.

17. The system of claim 13, wherein the controller is configured to determine and activate an emergency stop mode of the drive system when it is determined the power has failed.

18. The system of claim 17, wherein the emergency stop mode is determined based on a state of the elevator car at the time it is determined the power has failed.

19. The system of claim 18, wherein the state of the elevator car is at least one of (i) a direction of movement of the elevator car and (ii) a load in the elevator car.

20. The system of claim 13, wherein at least one of the controller and the drive system are configured to control the position of an elevator car to position the elevator at a target position.
